(19) United States
(12) Patent Application Publication
(10) Pub. No.: US 2013/0255905 A1
(43) Pub. Date: Oct. 3, 2013

(54) METHOD FOR PROCESSING OF HEAT ENERGY ABSORBED FROM THE ENVIRONMENT AND A UNIT FOR PROCESSING OF HEAT ENERGY ABSORBED FROM THE ENVIRONMENT

(71) Applicant: Ryszard Pakulski, Pozan (PL)

(72) Inventor: Ryszard Pakulski, Pozan (PL)

(21) Appl. No.: 13/488,272

(22) Filed: Jun. 4, 2012

(30) Foreign Application Priority Data
Apr. 2, 2012 (PL) P.398697

(51) Int. Cl. F28D 20/00

(52) U.S. Cl. 165/8

(57) ABSTRACT

The subject of the invention is a method for processing of heat energy absorbed from the environment and a unit for processing of heat energy absorbed from the environment, used for the supply of energy load points, especially electric load points, especially in places with large and frequent changes of environment temperature. The system uses an energy accumulator, which is connected to an actuating element through an energy level controller. This method is implemented in a stand-alone unit, wherein an energy level controller is placed between the energy accumulator and the actuating element.

### CROSS REFERENCE TO RELATED APPLICATIONS

This application claims the benefit of priority pursuant to 35 U.S.C .§119 and the Paris Convention, to the Polish Patent Application No. P 398697 filed Apr. 2, 2012, the contents of the application is incorporated herein by reference.

### BACKGROUND OF THE INVENTION

The subject of the invention is a method for processing of heat energy absorbed from the environment and a unit for processing of heat energy absorbed from the environment, used for the supply of energy load points, especially electric load points, especially in places with large and frequent changes of environment temperature.

The subject matter of the invention is an improvement to known methods of obtaining of energy, also electric energy, from natural sources of energy, and methods used for the transformation of natural energy in useful energy.

Humanity has, for a long time, used wind energy, transformed in various devices into driving energy for load points, such as mills and other driving force load devices. With the development of technology and the invention of electrical current, the wind energy was used to drive power generators.

The energy of water was also used, with the water flow energy driving various types of devices transforming this energy to useful energy, supplying various types of load points, and also driving electric power generators.

Solar power was also used, transformed in devices into useful energy for heating or supplying of other electric current load points.

All the listed sources of natural energy may be used only when this energy is present in a limited location, such as water-power plants, or at a limited time, like solar batteries or wind-power plants, which reduces the usefulness of its usage.

The solution used in the description GB 984268 has a filament located in an air bellows, in which it heats the air, which as a result of thermal expansion creates increased pressure, enabling the lengthening of the bellows and applying force to a moving element of the end of the bellows.

In the solution in the JP 61089975 patent, the piezoelectric phenomenon was used to move the needle powering the piston of the load point.

The system described in U.S. Pat. No. 5,822,989 presents a friction brake switch, in which the element applying pressure to disks through a bearing is a set of sockets with polymers, expanding through the phenomenon of thermal expansion.

A solution is known, presented in Polish Patent description no 210333 in which the method of transforming of heat energy from the environment, the essence of which is having an element with a high thermal expansion coefficient is connected mechanically with a moving element of an energy accumulator, which is then connected to an actuating element, which is then connected to the load point.

### BRIEF DESCRIPTION OF THE DRAWINGS

FIG. 1 is a flowchart of a one embodiment of the invention;

FIG. 2 is a flowchart of another embodiment of the invention;

FIG. 3 is a diagram of a unit for one embodiment of the invention; and

FIG. 4 is a diagram of a unit for another embodiment of the invention.

### SUMMARY OF THE INVENTION

This method is realised in the unit, which consists of an element with a high thermal expansion coefficient, connected mechanically with a moving element of an energy accumulator, which is then connected to an actuating element, which is connected to the load point.

The goal of the invention is to eliminate the abovementioned defects and problems and to propose a method which enables the transformation of heat energy from the surrounding to another form of energy and a unit for the implementation of this method.

### DETAILED DESCRIPTION

The essence of the invention, which is a method of transforming of heat energy, absorbed from the environment, having an element with a high thermal expansion coefficient, connected mechanically on at least one end with a moving element of an energy accumulator, which is then connected to an actuating element, which is then connected to the load point, consists of an energy accumulator connecting to an actuating element through an energy level controller.

It is advantageous, when a mechanical controller is used as an energy level controller.

It is also advantageous, when a flow choke with outflow control is used as an energy level controller.

It is also advantageous, when a bimetallic system is used as an energy level controller.

It is also advantageous, when a multi-joint flat system is used as an energy level controller.

This method is used in an unit for the transforming of heat energy, absorbed from the environment, the essence of which consists of having an element with a high thermal expansion coefficient, connected mechanically on at least one end with a moving element of an energy accumulator, which is then connected to an actuating element, wherein between the energy accumulator and the actuating element an energy level controller is placed.

It is advantageous, when the energy level controller is a mechanical controller.

It is also advantageous, when the energy level controller is a flow choke with outflow control.

It is also advantageous, when the energy level controller is an electric controller.

It is also advantageous, when the energy level controller is a bimetallic system.

It is also advantageous, when the energy level controller is a multi joint flat system.

The use of the solution presented in the invention enables the following technical and utility effects:

the ability to use heat energy drawn from the environment when the environment temperature changes and to use it into technically usable energy,

the ability to control the amount of energy transferred to the load point,

the ability to supply energy load points regardless of the time of the day and year,

maintenance-free device,

the ability to use to use in any time and place regardless of the presence of sun, wind and flowing water stream and to supply energy to any load point.

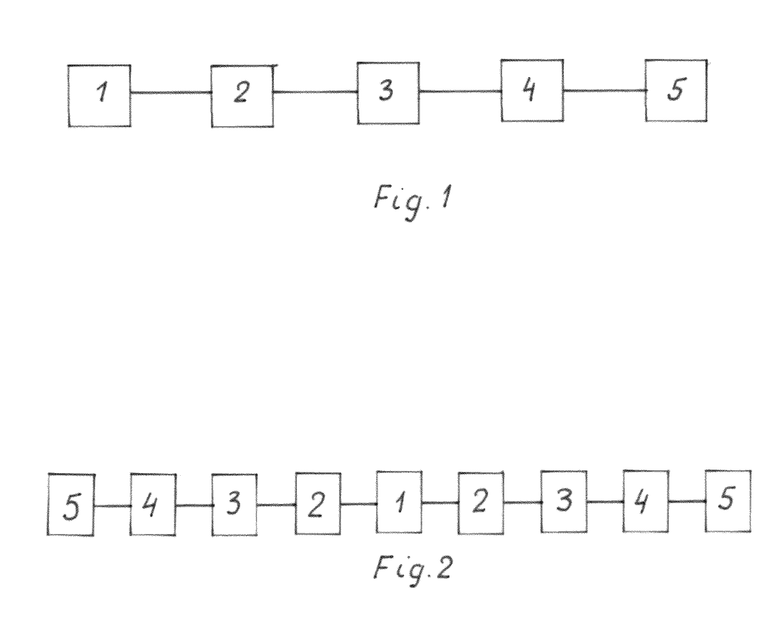

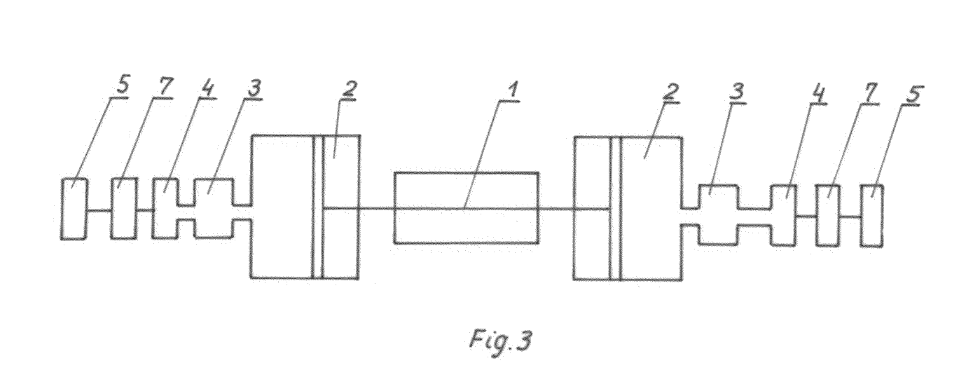

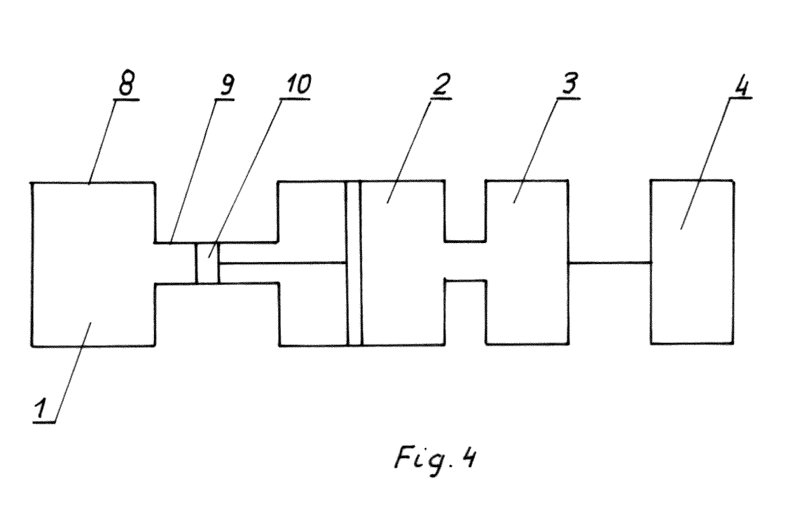

The subject of the invention in a sample implementation was described in below examples and was shown on the drawing, where on FIG. 1 a flowchart with a one-sided power draw is presented, on FIG. 2 a flowchart with a two-sided power draw is presented, on FIG. 3 a diagram of the unit for transforming the heat energy with an element with lengthwise thermal expansion direction is presented, and on FIG. 4 with an element with volumetric thermal expansion is presented.

The unit in one of the implementation versions is formed of an element 1 with a large of lengthwise thermal expansion coefficient, which is advantageously a rod. This rod is connected mechanically with a moving element of the energy accumulator 2, which is then connected by an energy level controller 3 with an actuating element 4, to which an energy load point 5 is connected. The energy accumulator 2 in one of non-limiting versions of implementation is a closed fluid tank, in which a sliding piston 6 is placed, which is the moving element of the energy accumulator 2. Energy accumulator 2 within the closed space wall has an energy level controller 3, which is a variable flow nozzle with an outlet in the turbine blades zone, forming the actuating element 4. Turbine 4 is mechanically connected with the alternator 7, which is connected with an energy load point 5, which is advantageously a battery for powering of other electric load points, not shown on the drawing.

In other implementation version the turbine 4 is connected with an alternator 7 through a mechanical transmission.

In another implementation version the element 1 has pistons 6 of energy accumulators 2 mounted on both ends, which, as in the implementations above are connected by a mechanical energy level controller 3 with actuating elements 4 and energy load points 5.

Depending on the version of implementation, the energy level controller is a a mechanical flow choke, with outflow control, electric controller, bimetallic system, or a multi-joint flat system

There are versions, presented on FIG. 4, in which element 1 is a high thermal expansion coefficient medium, advantageously gas, fluid, mercury or other medium. This medium is closed in a container 8, having a cylinder 9 with a piston 10. The piston 10 is connected with a sliding element of an energy accumulator 2, which through an electric energy level controller 3 is connected to an actuating element 4.

In a next version of implementation, not shown on the drawing, the energy accumulator 2 is a set of springs, of which one is compressed and another one is stretched. The springs are connected with the end of the element 1 and with the known element for transforming the potential energy of the spring to kinetic energy, which sends this energy to the impeller of the generator 8.

Change of the environment temperature causes the change of the length of the element 1 and movement of the piston 6. In another implementation the change of the environment temperature causes the increase of the volume of the medium 1 in the container 8 and the movement of piston 10 in the cylinder 9, and thus the movement of the piston of the energy accumulator 2. In one of the versions of the implementation the fluid contained in the energy accumulator 2 will be injected by a nozzle 3 onto the blades of the turbine 4. Turbine 4 drives the alternator 7 directly or through a mechanical transmission. The current created in the alternator 7 powers the energy load point 5.

In another version of the implementation the change of length of the element 1 causes the movement of two pistons 5 in energy accumulators 2 and causes the turbines 3 to drive two alternators 7.

To increase the clarity of the description, we have resigned to present the solution of the energy amount control systems 3 depending on the direction of the temperature gradient changes.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting, but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

The embodiment of the invention in which an exclusive property or privilege is claimed is defined as follows:

1. A method of transforming of heat energy, absorbed from the environment, comprising providing an element with a high thermal expansion coefficient, connecting said element mechanically on at least one end with a moving element of an energy accumulator, connecting the moving element to an actuating element, connecting the actuating element to a load point, wherein an energy accumulator is connected to the actuating element through an energy level controller.

2. The method in accordance with claim 1, wherein the energy level controller comprises a mechanical controller.

3. The method in accordance with claim 1, wherein the energy level controller comprises a flow choke with outflow control.

4. The method in accordance with claim 1, wherein the energy level controller comprises an electric controller.

5. The method in accordance with claim 1, wherein the energy level controller comprises an bimetallic system.

6. The method in accordance with claim 1, wherein the energy level controller comprises a multi-joint flat system.

7. A unit for transforming of heat energy, absorbed from the environment, comprising an element with a high thermal expansion coefficient, wherein said element is connected mechanically on at least one end with a moving element of an energy accumulator, wherein said accumulator is in turn connected to an actuating element, wherein the actuating element is then connected to a load point, wherein an energy level controller is located between the energy accumulator and the actuating element.

8. The unit in accordance with claim 7, wherein the energy level controller comprises a mechanical controller.

9. The unit in accordance with claim 7, wherein the energy level controller comprises a flow choke with outflow control.

10. The unit in accordance with claim 7, wherein the energy level controller comprises an electric controller.

11. The unit in accordance with claim 7, wherein the energy level controller comprises a bimetallic system.

12. The unit in accordance with claim 7, wherein the energy level controller comprises a multi-joint flat system.
